(19) United States
(12) Patent Application Publication
(10) Pub. No.: US 2021/0012255 A1
(43) Pub. Date: Jan. 14, 2021

(54) CONCISELY AND EFFICIENTLY RENDERING A USER INTERFACE FOR DISPARATE COMPLIANCE SUBJECTS

(71) Applicant: Huntington Ingalls Industries, Inc., Newport News, VA (US)

(72) Inventors: Mitchell T. THOMPSON, Vancleave, MS (US); Charles NEFF, Carrollton, VA (US)

(21) Appl. No.: 17/034,756

(22) Filed: Sep. 28, 2020

Related U.S. Application Data
(63) Continuation-in-part of application No. 15/809,519, filed on Nov. 10, 2017.
(60) Provisional application No. 62/531,049, filed on Jul. 11, 2017.

(51) Int. Cl. G06Q 10/06; G06Q 10/10

(52) U.S. Cl. CPC G06Q 10/0635; G06Q 50/265; G06Q 10/063114; G06Q 10/105

(57) ABSTRACT

Disclosed are systems and methods for rendering a graphical user interface. The described technique includes determining a risk score for an entity in an organization and a consequence score associated with the compliance subject. The risk score indicates a likelihood of misconduct associated with a compliance subject by an employee within the entity. A graphical user interface having a risk plot region is generated. The risk plot region has at least one graphical indicator associated with the compliance subject and rendered in a location within the risk plot region based on the risk score and corresponding consequence score. The graphical indicator displays a frequency count of compliance subjects having the associated risk score and corresponding consequence score, and is selectable to display a list of the compliance subjects included in that frequency count.

### CROSS-REFERENCE TO RELATED APPLICATIONS SYSTEM

This application is a continuation-in-part of U.S. patent application Ser. No. 15/809,519, titled “System and Method for Rendering Compliance Status Dashboard” and filed on Nov. 10, 2017, which is incorporated by reference herein in its entirety and claims the benefit of U.S. Provisional Application No. 62/531,049, filed Jul. 11, 2017.

### FIELD OF TECHNOLOGY

The present disclosure relates generally to a graphical user interface, and more specifically to concisely and efficiently rendering a user interface for disparate compliance subjects.

### BACKGROUND

Modern organizations or enterprises have complex corporate structures, including many entities such as business units, subsidiaries, as well as many third party companies within a supply chain for the corporation. For example, the following areas have various risks that require compliance within an organization: antitrust, business ethics awareness, business gratuities, conflict minerals, cost accounting system requirements, cybersecurity, data breach laws, and other compliance subjects.

Existing user interfaces and other technologies (e.g., web applications) include functionality for computing enterprise-related tasks (e.g., via linear-based calculations). For example, some applications can calculate loss of profits, merchandise damages, risk assessment, and risk compliance. Existing user interfaces and applications require the arduous drilling down, navigation, and browsing of various views or pages in order to view specific enterprise-related computations, such as risks for certain business units and whether there is certain compliance for such risk. Further, the specific computation functionality of these user interfaces and technologies is static and inaccurate, and causes unnecessary computer resource consumption (e.g., network latency), as described in more detail herein.

Moreover, real-time instantaneous changes distributed among different business units or other such entities and concerning such disparate compliance subjects are not only difficult to track, but are likewise difficult to compare and quantify in real-time. Making sense of large amounts of compliance data across multiple entities within the corporate structure, as well as the resulting implications for an organization's compliance risks in a comprehensive and efficient manner is not possible with today's data management tools. For example, electronic spreadsheet applications with different columns, rows, or tabs for different entities or compliance subjects could be utilized, but the complexity of large spreadsheets has long been a problem for users and would not allow simultaneous and effective comparisons of such disparate data. Such spreadsheets of data also require scrolling to see all of the data and/or navigating between tabs.

### SUMMARY

Embodiments of the present disclosure describes a system configured to provide a tool and user interface to manage compliance matters based on a behavioral risk assessment of rationalization, opportunity, and pressure characteristics. As described below, the system plots a risk indicator based on human behavior analysis. Other tools are described within to facilitate managing the risk associated with the risk indicator. Existing user interfaces and technologies fail to simultaneously present (e.g., via a summary portion) and effectively weigh various risks and related considerations in regards to disparate data from different entities within or associated to an organization and disparate compliance subjects having varying requirements and factors associated therewith Accordingly, existing user interfaces and technologies tend to be inaccurate and require the arduous drilling down, navigation, and browsing, thereby negatively affecting the user experience. This also negatively affects computer resource consumption, such as throughput and network latency. However, the present technological solution provides a highly intuitive, user-friendly interface solution providing simplified navigation and presentation of disparate data, thereby improving the efficient functioning of computers as described herein. Specifically, the present solution overcomes the deficiencies of existing technologies in terms of a specific user interface configured to better aggregate, quantify, compare, and display an organization's risks and consequences in regarding to various compliance subjects. For example, various embodiments generate a “summary portion” and “summary reports” and reduce network latency, as described in more detail herein. The risks are quantified by scoring methods described herein which standardize diverse data regarding diverse compliance subjects and presents such data in a manner that is simple to interpret and to navigate, thereby providing a structured output from an otherwise unstructured input.

According to one aspect of the present disclosure, a method is provided for standardized tracking and comparison of risks and consequences associated with a plurality of compliance subjects using a graphical user interface. The method includes determining a risk score for an entity in an organization or enterprise. The risk score indicates a likelihood of misconduct associated with a compliance subject by an employee within the entity. The method further includes determining a consequence score associated with the compliance subject, generating a graphical user interface comprising a risk plot region, and causing a rendering of a graphical indicator in a specific location within the risk plot region. The rendering is caused within the graphical user interface at least partially in response to the determining of the risk score and the consequence score. The graphical indicator comprises a frequency count of compliance subjects having the associated risk score and corresponding consequence score.

In another exemplary aspect, a system for monitoring status of compliance subjects using a graphical user interface is provided. The system includes a display device, and a processor. The processor is configured to determine a risk score for an entity in an organization, wherein the risk score indicates a likelihood of misconduct associated with a compliance subject by an employee within the entity. The processor is further configured to determine a consequence score associated with the compliance subject. The processor is configured to generate, for display on the display device, a graphical user interface comprising a risk plot region, wherein the risk plot region comprises at least one graphical indicator associated with the compliance subject and rendered in a location within the risk plot region based on the risk score and corresponding consequence score. The at least one graphical indicator further includes a frequency count of compliance subjects having the associated risk score and corresponding consequence score.

According to another exemplary aspect, a computer-readable medium is provided comprising instructions that comprises computer executable instructions for performing any of the methods disclosed herein.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for rendering a compliance status dashboard according to an exemplary aspect.

FIG. 2 is a flowchart illustrating a method for performing a risk assessment and monitoring status of compliance subjects using a graphical user interface according to an exemplary aspect.

FIG. 3 is a block diagram depicting a scheme for risk assessment pf employee misconduct according to an exemplary aspect.

FIGS. 4A and 4B illustrate views of a graphical user interface for rendering a compliance risk dashboard for a compliance user according to an exemplary aspect.

FIG. 5 depicts a graphical user interface for rendering a compliance risk dashboard for a compliance manager according to an exemplary aspect.

FIG. 6 depicts a graphical user interface for rendering a compliance risk dashboard for a user according to an exemplary aspect.

FIG. 7 depicts a graphical user interface for rendering a compliance risk dashboard for a user according to an exemplary aspect.

FIGS. 8 and 9 depict graphical user interfaces for rendering summary reports on compliance risk status according to an exemplary aspect.

FIG. 10 depicts a graphical user interface for specifying a core element according to an exemplary aspect.

FIG. 11 depicts a graphical user interface for determining a risk assessment of a core element or compliance subject according to an exemplary aspect.

FIG. 12 depicts a graphical user interface for generating a risk mitigation plan for a core element or compliance subject according to an exemplary aspect.

FIG. 13 depicts a graphical user interface for displaying and editing training status information for a core element or compliance subject according to an exemplary aspect.

FIG. 14 depicts a graphical user interface for generating an evaluation of a core element or compliance subject according to an exemplary aspect.

FIG. 15 is a block diagram of a general-purpose computer system on which the disclosed system and method can be implemented according to an exemplary aspect.

### DETAILED DESCRIPTION

Exemplary aspects are described herein in the context of a system, method, and computer program product for monitoring status of compliance subjects using a graphical user interface. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure includes embodiments that provide a tool to manage disparate compliance matters for disparate entities and sub-entities based on a behavioral risk assessment of rationalization, opportunity, and pressure characteristics. As described below, various embodiments plot a risk indicator based on human behavior analysis. Other tools are described within to facilitate managing the risk associated with the risk indicator. Existing user interfaces and technologies struggle to simultaneously present and effectively weigh various risks and related considerations in regards to disparate data from different entities within or associated to an organization and disparate compliance subjects having varying requirements and factors associated therewith. For example, although technologies such as “THE LOGICGATE RISK CLOUD,” and “CYBERGRX” include risk management and risk compliance functionality, these technologies as well as others, such as electronic spreadsheets, require users to drill down various pages to find relevant information. For example, if users wanted to view risk compliance for different sub-departments, users must drill down from a dashboard or landing page into a department page (e.g., a marketing sales department page), and then have to drill down yet again from the department page to the sub-department page (e.g., a product X marketing team page). This is not only arduous and time consuming to negatively affect the consumer experience, it unnecessarily consumes computer resources, such as network latency and throughput, among other things.

Each drill down click or other user input requires packet generation costs (e.g., input header information) for network protocols (e.g., TCP/IP), which increases network latency after repeated drill-downs are transmitted over a network. For instance, each time a user clicks on a page or issues a different query obtain various enterprise-related information, packet headers are exchanged and the payload of the data has to traverse the network. Further, if users repetitively issue queries to get the desired enterprise-related information, it is computationally expensive. For example, an optimizer engine of a database manager module calculates a query execution plan (e.g., calculates cardinality, selectivity, etc.) each time a query is issued, which requires a database manager to find the least expensive query execution plan to fully execute the query. This decreases throughput and increases network latency, and can waste valuable time. Most database relations contain hundreds if not thousands of records. Repetitively calculating query execution plans for extensive drilling to obtain the desired enterprise-related information decreases throughput and increases network latency.

However, the present solution provides a highly intuitive, user-friendly interface solution. Specifically, the present solution overcomes the deficiencies of existing technologies in terms of a specific user interface configured to better aggregate, quantify, compare, and display an organization's risks and consequences in regard to various compliance subjects. The risks are quantified by scoring methods described herein which standardize diverse data regarding diverse compliance subjects and presents such data in a manner that is simple to interpret and to navigate, thereby providing a structured output from an otherwise unstructured input. For instance, using the example above, instead of the user having to drill down various pages to obtain enterprise-related information for the sub-department, that sub-department's page information can be provided to a “summary portion” or “summary report,” along with various other departments or sub-departments, which is described in more detail herein. This reduces the requirement for extensive drilling down, browsing, clicking, and querying needed to obtain specific department or other enterprise-related information.

In another example, scores assigned to entities for different compliance subjects are determined based on various criteria stored, accessed via the systems described herein, and/or selected by a user. Specifically, risk scores determined herein are based on an ability of the employee to justify an act of misconduct, a difficulty with which the employee can commit the act of misconduct, and a motive for the employee to commit the act of misconduct. Consequence scores corresponding to financial or reputational impact of an act of misconduct are also calculated for each entity. A method herein plainly and efficiently displays this information on a risk cube plot, with one axis corresponding to risk score and another corresponding to consequence score, and circles at a plurality of coordinates thereon indicating a frequency count of the compliance subjects having the associated risk score and corresponding consequence score. Separate risk cube plots may be displayed for each entity and/or one risk cube plot may be displayed for a combination of multiple entities associated with an organization. Furthermore, the methods and systems described herein can allow the frequency counts on the risk cube plot to be selectable by a user, such that selection thereof results in a display of the names of compliance subjects associated with that risk assessment point.

Thus, the user interface described herein improves user experience by providing an at-a-glance overview of risks and consequences for an organization and/or its associated entities and the frequency count of compliance subjects associated with those risk and consequence scores. It also advantageously improves user experience by providing a more simplified way of navigating such data, via user selection of the frequency count, to identify and display the compliance subjects represented by that frequency count. Methods of using the risk cube plots disclosed in detail herein thus allows a user to visually identify when numerous compliance subjects have risk and consequence scores of concern in a given situation within an organization and to instantly select and view a listing of those compliance subjects, as opposed to more complex filtering techniques for parsing such data. This unique configuration also allows a user to avoid the burdensome task of excessive scrolling and/or navigating through data in separate windows using arbitrary filtering techniques to identify compliance subjects of concern.

Because the user does not have to perform extensive drilling, browsing, querying, and navigating, computing resource consumption is also improved. For example, by generating a user interface that summarizes or displays all the relevant risk and consequence information on a single page or dashboard, there are only network generation costs for requesting the page or dashboard, and no packet header formulation and payload exchange needed for navigating to different pages because the user does not need to keep drilling down to request information from various sub-pages, and the like. This means that there is no network protocol communication between a user device (e.g., a client device, such as a mobile device) and one or more servers hosting web pages, and the like. Accordingly, there would be no header formation of packets and handshake steps (e.g., SYN, SYN-ACK, an ACK) subsequent to the providing of the summary portion or report. Therefore, there is less overhead and reduced traffic exchange, thereby freeing up bits to be transferred over the entire network for any given time slice for bandwidth purposes.

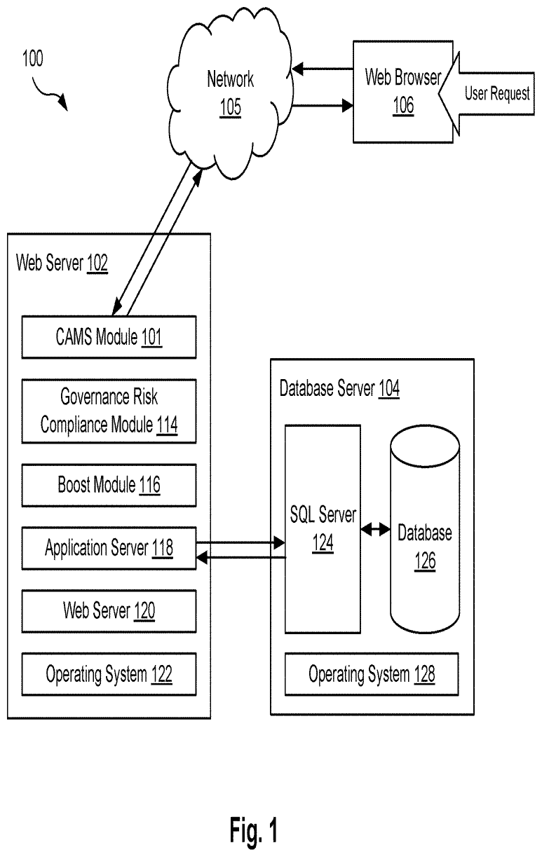

FIG. 1 is a block diagram illustrating a system 100 for rendering a compliance status dashboard according to an exemplary aspect. The system 100 includes a compliance assessment management software (“CAMS”) module 101 configured to perform a risk assessment of employees within an organization according to a risk methodology. The CAMS module 101 may be configured to generate a dashboard indicating risk of misconduct within one or more entities of the organization (e.g., business units, subsidiaries) in one or more compliance subjects (referring to herein as “core elements.”)

In one aspect, the CAMS module 101 may be implemented as a multi-tier web application. Accordingly, the system 100 may include a web server 102 and a database server 104. The web server 102 may include the CAMS module 101, a governance risk compliance module 114, and a boost module 116 executing as software components of an application server 118. Examples of the application server 118 include Adobe ColdFusion®, PHP Application Server, or Java Application Server®. The web server 102 may further include web server software 120 executing in an operating system 122. In one example, the web server 102 may include Internet Information Services® (IIS) web server made available from Microsoft® executing on a Microsoft Windows Server®. The application server 118 may be configured to communicate with a backend component, such as a database server 104 having an SQL server 124 and a database 126 executing in an operating system 128. Examples of SQL servers 124 may include MS SQL Server®, MySQL®, and MongoDB®. It is understood that other types of databases or data stores may be used in the described system, such as NoSQL-type databases.

In operation, a web browser 106 submits one or more user requests, via a network 105 (e.g., Internet), to the CAMS module 101. In response, the CAMS module 101 may generate a graphical user interface having a compliance subject status dashboard. The compliance subject status dashboard may assist a user with determining what can be done to reduce the likelihood of misconduct within the organization. The compliance subject status dashboard may further provide an evaluation of the risk assessment based on rationalization, opportunity, pressure, and consequence (collective referred to as “ROPC”) over time. The CAMS module 101 may be further configured to generate a mitigation strategy based on the risk assessment, and provide management tools that enable a user (e.g., compliance officer) to drive risk reduction by managing the plan's status regularly. In some embodiments, the CAMS module 101 may aggregate risk data in order to generate streamlined visualizations of the risk data.

In some aspects, the CAMS module 101 may be configured to identify one or more core elements within an enterprise, as well as one or more risk considerations related to those core elements, and perform risk assessment based on the core elements and risk considerations. The phrase “core elements” as used herein may refer to compliance-related categories or compliance subjects, such as antitrust, business ethics awareness, business gratuities, cybersecurity, data breach laws, discrimination (EEO Compliance), environmental, FAR mandatory disclosures, Federal Awardee Performance and Integrity Information System (FAPIIS), federal political activities, harassment, health and safety, human trafficking, import/export, insider trading, and other subjects.

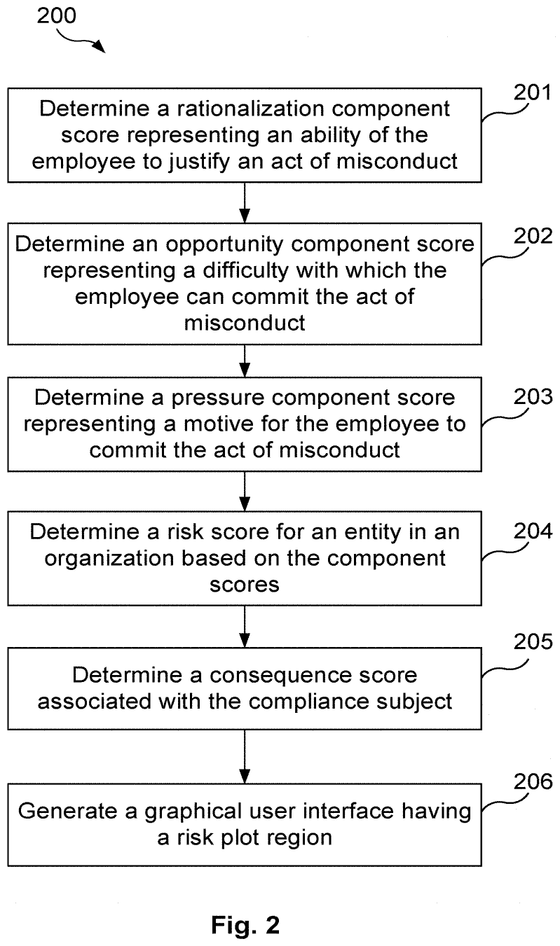

FIG. 2 is a flowchart illustrating a method 200 for performing a risk assessment and monitoring status of compliance subjects using a graphical user interface according to an exemplary aspect. It is noted that the following description of the exemplary method makes reference to the system and components described above.

The method 200, begins at step 201, which the CAMS module 101 may determine a rationalization component score (“R”) that represents the ability of an employee to justify an act of business misconduct. In some embodiments, the CAMS module 101 may retrieve the rationalization component score associated with one or more compliance subjects from a database, such as the database 126. In one embodiment, the CAMS module 101 may use numeric terms to represent the likelihood of misconduct within the rationalization component score (as well as opportunity and pressure component scores described below). For example, the likelihood terms may correlated to a numerical scale from 0 to 5, where the higher the number, the more “likely” an act of misconduct could occur. In determining the R score, the CAMS module 101 may take further considerations into account when determining the risk level of an employee, such as the availability of training, the effectiveness of training, communication campaigns, whether an employee understands disciplinary actions, whether disciplinary action have been demonstrated recently in the past, the tone from the top on this subject, the tone in the middle, whether a core element is “new”, indications of potential issues that relate to this particular topic, and whether any other data or events within the business element are relevant to this core element, including audits, studies, awards, and customer feedback results.

Tables 1 to 4 below provide criteria used by the CAMS module 101 to determine rationalization, opportunity, and pressure component scores, and the consequence score. In each table, the descriptions of various likelihood levels provides a risk assessor(s) with criteria that, if true, would correspond to the “likelihood” 0-5 score. If the risk assessor(s) determine that the criteria of a level is not “true,” the accessor(s) would move to the next level until a criteria is determined to be “true.” Table 1 below is a chart for determining a rationalization component score that represents the ability of an employee to justify an act of business misconduct.

TABLE 1
RATIONALIZATION COMPONENT SCORE

| Likelihood | Description |
|---|---|
| Highly Likely = 5 | Standards, rules, and guidelines are vague or do not exist OR |
| (Red) | Disciplinary standards are not developed OR |
| | Disciplinary actions are viewed as inconsistent OR |
| | Increasing trend of misconduct |
| Likely = 4 | Standards, rules, and guidelines are underdeveloped OR |
| | Minimal awareness of employee expectations OR |
| | Disciplinary standards developed but not communicated and with |
| | inconsistent disciplinary action OR Recent event (s) of misconduct |
| Somewhat Likely = 3 | Standards, rules, and guidelines are developed with sporadic |
| | communications OR |
| | Employee awareness not understood OR |
| | Disciplinary standards are communicated regularly and disciplinary |
| | action is fair but with some inconsistencies OR Some history of |
| | misconduct |
| Not Likely = 2 | No recent history of misconduct AND |
| | Standards, rules, and guidelines are developed and communicated |
| | consistently and employee awareness is demonstrated AND |
| | Disciplinary standards are communicated regularly and disciplinary |
| | action is fair and consistent |
| Very Unlikely = 1 | No recent history of misconduct AND |
| | Limited opportunity to engage in misconduct AND |
| | Standards, rules, and guidelines are developed and communicated |
| | consistently and are well understood AND disciplinary standards are |
| | communicated regularly |
| Highly Unlikely = 0 | No known personal benefit from misconduct AND |
| (Green) | Performance pressure does not exists AND |
| | Performance measures are historically achieved with margin |

At step 202, the CAMS module 101 may determine an opportunity component score (“0”) that represents the ease or difficulty with which an employee can commit misconduct. In some embodiments, the CAMS module 101 may determine the component score by retrieving the opportunity component score associated with one or more compliance subjects from a database, such as the database 126. In determining the 0 score, the CAMS module 101 may take further considerations into account when determining the risk level of an employee, such as whether controls exist, whether the controls have demonstrated effectiveness, whether there are leading indicators that exist but are not monitored, whether misconduct has occurred for a period of time before a control detects it, the results of any recent controls audits, and whether any misconduct has been self-reported. The CAMS module 101 may further determine the 0 component score based on whether there are any corrective actions or internal findings on record, considerations of other stakeholder functions in the assessment of the controls, and further based on any other data or events within the business unit relevant to the core element, such as audits, studies, awards, and customer feedback results. Table 2 is a chart for determining an opportunity component score (“0”) that represents the ease with which an employee can commit misconduct, from a scale from 0 to 5.

TABLE 2
OPPORTUNITY COMPONENT SCORE

| Likelihood | Description |
|---|---|
| Highly | No known internal controls exist |
| Likely = 5 | |
| (Red) | |
| Likely = 4 | Controls exist, but have not been tested OR |
| | Controls have been overridden or circumvented OR |
| | Controls have not been audited OR |
| | Increasing trend of event(s) for failed control |
| Somewhat | Controls exist with some history of detection OR |
| Likely = 3 | Potential to override without detection OR |
| | Unlikely to be audited OR |
| | Recent event(s) of failed control |
| Not | No recent history of failed control AND |
| Likely = 2 | Controls exist with some automation with demonstrated |
| | effectiveness in detection and prevention OR |
| | Undetected override of control is unlikely OR |
| | Control is routinely audited OR |
| Very | Automated and/or manual controls with demonstrated |
| Unlikely = 1 | effectiveness in detection and prevention AND |
| | No override capability AND |
| | Routinely audited w/no history of findings AND |
| | No history of failed control |
| Highly | Controls are completely automated and demonstrate |
| Unlikely = 0 | effectiveness in detection and prevention AND |
| (Green) | No override capability AND |
| | Routinely audited with no history of findings AND |
| | No history of failed control |

At step 203, the CAMS module 101 may determine a pressure component score (“P”) representing a motive or incentive for employees to commit misconduct. In some embodiments, the CAMS module 101 may determine the component score by retrieving the pressure component score associated with one or more compliance subjects from a database, such as the database 126. In some aspects, the CAMS module 101 may determine the P component score based on whether the organization has engaged in messaging and behavior that emphasizes performance with integrity, evidence of strong “tone” from all levels of leadership on ethics and compliance, whether the behavior could result from the measures in place, retaliation scores, and engaging in misconduct for this core element has good engagement scores. The CAMS module 101 may further determine the P component score based on whether the employee has been trained on ethics and compliance and is familiar with the compliance plans, whether the employee has achieved targets in the past, whether the employee has benefits from misconduct in the past, whether support structures and resources are readily available, whether known recent or future events give cause for concern that an employee could perform an act of misconduct in retaliation of the event, whether goals and expectations were communicated on a regular basis and were understood, whether feedback on performance (positive, constructive, etc.) was received, and any other data or events within the business unit relevant to the core element (e.g., audits, awards, studies, customer feedback). Table 3 is a chart for determining a pressure component score (“P”) that represents the motive or incentive for employees to commit misconduct.

TABLE 3
PRESSURE COMPONENT SCORE

| Likelihood | Description |
|---|---|
| Highly | Misconduct would significantly benefit employee OR |
| Likely = 5 | Performance pressure is perceived as intense/excessive OR |
| (Red) | Performance measure are viewed as unachievable OR |
| | Environment of fear exists |
| Likely = 4 | Misconduct will likely benefit the employee OR |
| | Performance pressure is high and sustained OR |
| | Performance measures are inconsistent and unlikely |
| | to be achieved |
| Somewhat | Misconduct may result in personal benefit to the |
| Likely = 3 | employee OR |
| | Performance pressure is high, but fluctuates OR |
| | Performance measures are inconsistent but achievable |
| Not | Very little personal benefit from misconduct OR |
| Likely = 2 | Performance pressure exists but is moderate OR |
| | Performance measures are consistent and achievable OR |
| Very | No known personal benefit from misconduct AND |
| Unlikely = 1 | Performance pressure exists but is minimal AND |
| | Performance measures are historically achieved |
| Highly | No known personal benefit from misconduct AND |
| Unlikely = 0 | Performance pressure does not exists AND |
| (Green) | Performance measures are historically achieved |
| | with margin |

At step 204, the CAMS module 101 may determine a risk score for an entity in an organization based on the rationalization component score, the opportunity component score, and the pressure component score. The risk score indicates a likelihood of misconduct associated with a compliance subject by an employee within the entity. In some aspects, the CAMS module 101 may calculate the risk score as a summation of numerical values of the rationalization component score, the opportunity component score, and the pressure component score.

At step 205, the CAMS module 101 may determine a consequence score associated with the compliance subject. The consequence score (“C”) may represent a determination of financial impact or reputational impact of an act of misconduct. In some embodiments, the CAMS module 101 may determine the consequence score by retrieving the consequence score associated with one or more compliance subjects from a database, such as the database 126. Table 4 below is a chart for determining a consequence score that represents the financial impact or reputational impact of an act of misconduct.

TABLE 4
CONSEQUENCE SCORE

| Impact | Financial | Reputation* |
|---|---|---|
| 5 | >$30M | Substantial; seen as not an employer of |
| | | choice; extensive media attention; |
| | | potential stockholder exit |
| 4 | $10M-$30M | Significant; jeopardized employee trust, |
| | | shipbuilder of choice jeopardized |
| 3 | >$5-$10M | Moderate; customer concern; questionable |
| | | practices |
| 2 | $1M-$5M | Minor; customer concern; minor trust |
| | | concerns from employees; some media intrusion |
| 1 | <$1M | Minimal; little to no impact |

In one embodiment, the consequence score may be represented on a numerical value on a scale from 1-5 that correlates to the determination of impact, where the lower the score, the lower the impact (see “Impact” column). The “Financial” Column of Table 4 indicates a level of financial impact based on a determined range of monetary impact that would cause concern for the company. The lower the financial monetary value, the lower the concern and correlating impact score. It is noted that the financial thresholds in this column may vary depending on the size of the company. For example, a company with sales in excess of $1B may have a Level 5 threshold of $30M whereas a company with sales around $50M may have a Level 5 threshold of $5M. Finally, the Reputation column describes varying levels of impact to a company's reputation in the event of a misconduct.

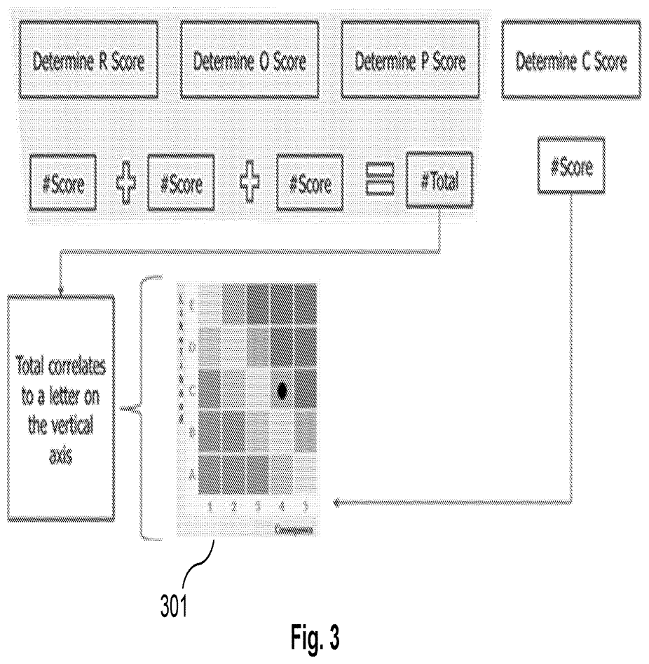

At step 206, the CAMS module 101 may generate a graphical user interface having a risk plot region. The risk plot region may include at least one graphical indicator associated with the compliance subject and rendered in a location within the risk plot region based on the risk score and corresponding consequence score. In some aspects, the graphical indicator includes a frequency count of compliance subjects having the associated risk score and corresponding consequence score. An example of a risk plot region is shown in FIG. 3 below.

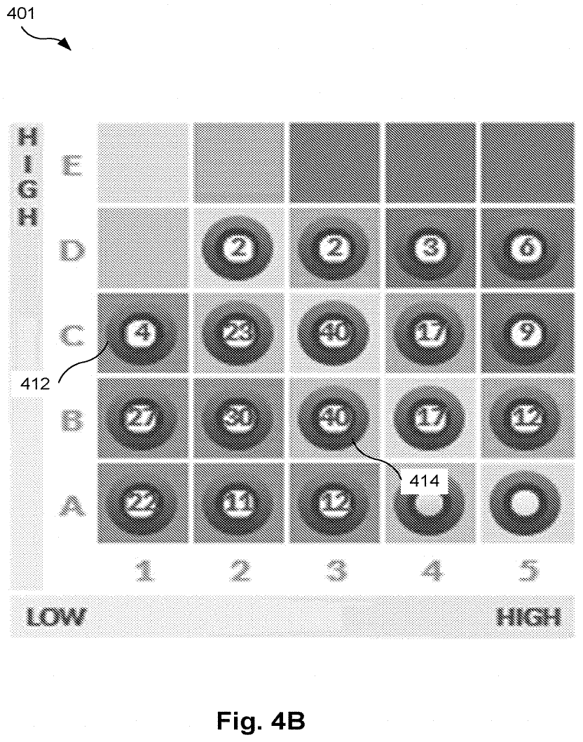

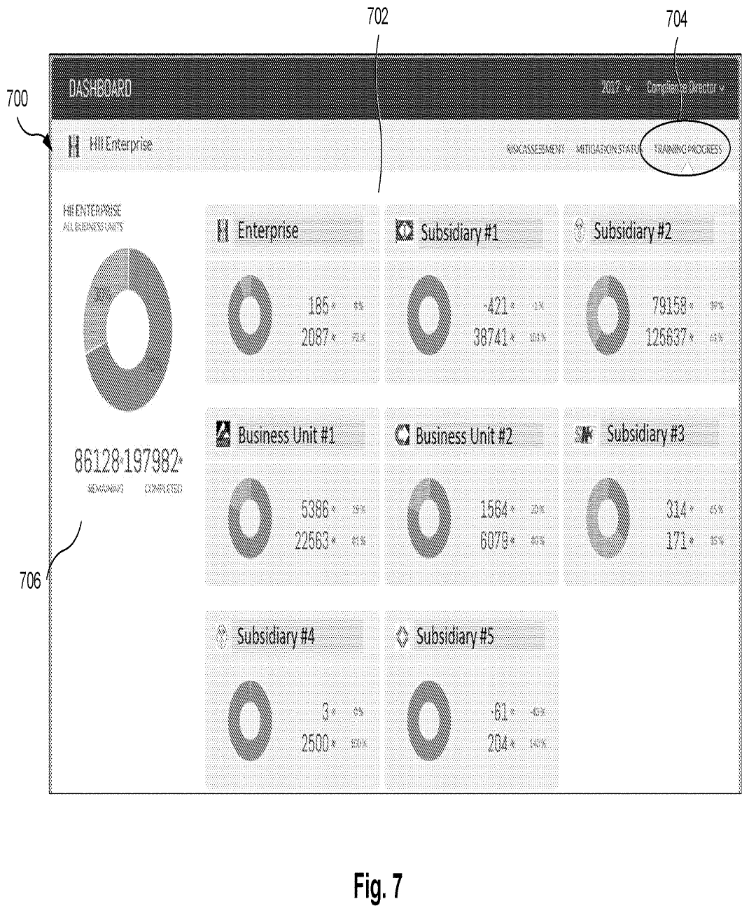

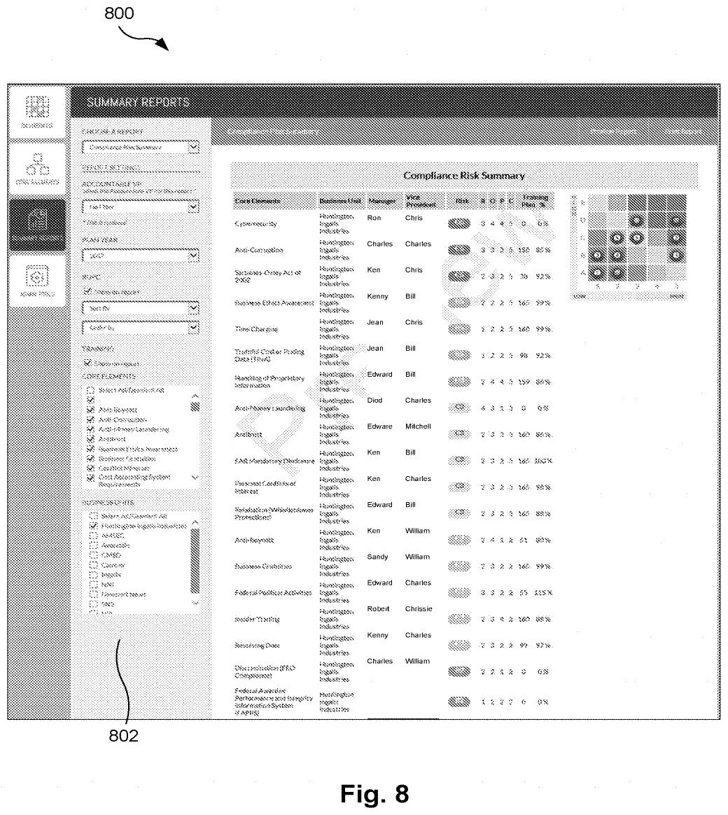

In some aspects, the CAMS module 101 may generate a graphical user having a mitigation status region. The mitigation status region may indicate a first proportion of open mitigation plans for reducing risk of misconduct, a second proportion of completed mitigation plans, and a third proportion of past due mitigation plans. In some aspects, the CAMS module 101 may further generate a graphical user interface having a training summary region. The training summary region may indicate a first proportion of employees having completed training related to the compliance subject and a second proportion of remaining employees to complete the training. Examples of mitigation status and training summary regions are shown in FIG. 5 below. In another aspect, the CAMS module 101 may generate another graphical user interface having a compliance risk summary, which indicates a plurality of compliance subjects and corresponding risk scores. An example of a compliance risk summary is shown in FIGS. 8 and 9 below.

FIG. 3 is a block diagram depicting a scheme for risk assessment of employee misconduct according to an exemplary aspect. As noted above, the CAMS module 101 may calculate the risk score as a sum total of numeric values representing the rationalization, opportunity, and pressure component scores associated with a core element, and determine a numeric value representing the consequence score. The CAMS module 101 may use the risk score and consequence score to generate an indication in a graphical representation referred to herein as a “risk cube plot” 301.

As shown in FIG. 3, the risk cube plot 301 includes a vertical axis corresponding to the risk score (e.g., likelihood), and a horizontal axis corresponding to the consequence score. In one implementation, the risk score may be discretized into certain levels (e.g., levels A to E). For example, if the risk score is between 0-3, then the graphical indication may be drawn on plot A. Similarly, if the risk score is between 4-6, then plot B; if between 7-9, then plot C; if between 1012, then plot D; and if between 13-15, then plot E. By way of example, if the CAMS module determines an R component score of 3, an O component score of 1, a P component score of 3, calculates the risk score as 7 (3+1+3=7), and determines a consequence score of 4, the resultant graphical indication may be rendered on plot C4.

In one aspect, the risk cube plot 301 may be colored with different colors indicating areas of low risk (e.g., green) and high risk (e.g., red). In some aspects, the risk cube plot 301 may be colored with a color gradient from green to red backgrounds from one corner of the risk cube plot 301 to the opposing corner. For example, the risk cube plot 301 may have a color gradient from green background squares in the lower left area (e.g., plots A1, B1, B2), transitioning to yellow background squares in a middle band regions (e.g., plots E1, D2, C3, B4, A5), and ending with red background squares in the upper right area (e.g., plots E4, E5, D5).

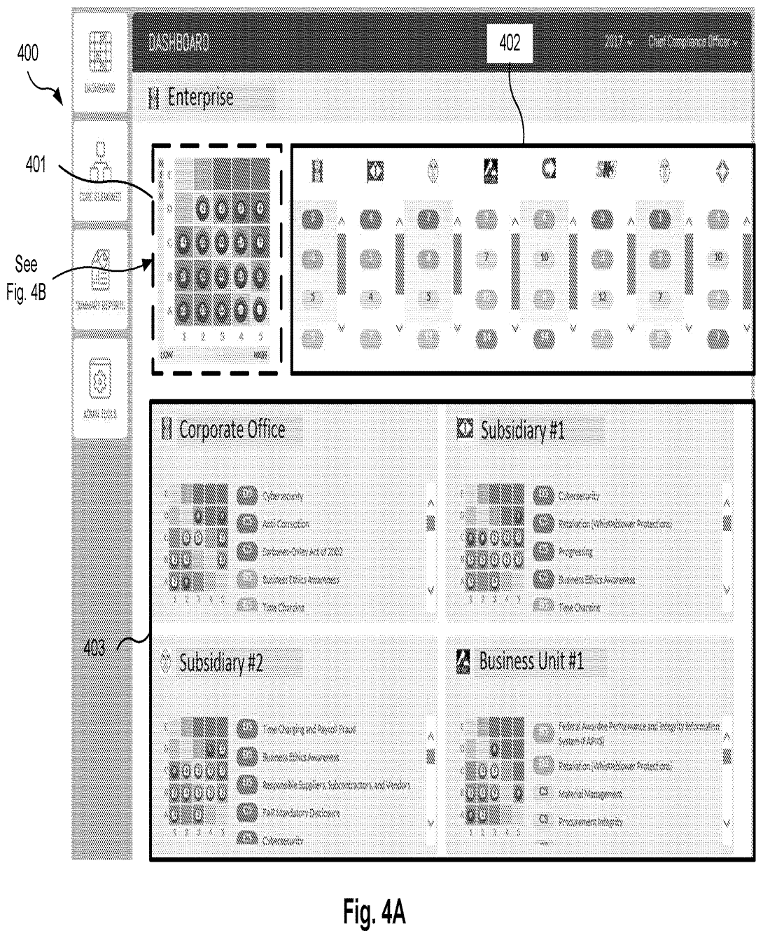

FIG. 4A illustrates a graphical user interface (GUI) 400 for rendering a compliance risk dashboard for a compliance user (e.g., chief compliance officer, compliance director) according to an exemplary aspect. The GUI 400 includes a first portion 401, which is a core element risk cube plot associated with the (entire) enterprise or corporation, which is shown in greater detail in FIG. 4B below. The GUI 400 further includes a summary portion 402, which indicates a prioritized risk summary broken down by business unit or subsidiary (depicted in FIG. 4A by individual logos). Small numbers indicate the number of core elements with a risk rating of the identified color. The GUI further includes a risk summary portion 403, which indicates a risk summary by business unit or subsidiary (e.g., “Corporate Office”, “Subsidiary 1”, “Subsidiary 2”, “Business Unit 1”) that includes titles of the core elements.

As described herein, the risk management method of the present disclosure provide the user with certain advantages over conventional systems. In contrast to conventional systems, the described graphical user interface method quickly generates a risk assessment overview of an entire organization across a multitude of compliance subjects. As described earlier, a modern corporate organization can span across large sub-organizations which may be independently operated with individual business processes. And the large sub-organizations, such as business units or subsidiaries, can each employ thousands to millions of employees. The described graphical user interface method enables a user, such as a top-level employee in an organization, to rapidly assess and take initiative to ameliorate the dangers of possible misconduct within minutes, instead of in weeks or months as otherwise might occur with conventional systems. For example, the prioritized risk summary portion 402 and risk summary portion 403 provide the user with concise information about risk assessments for all business units and subsidiaries within the organization. This saves users from navigating to records of different sub-organizations or different compliance subjects to enable data of interest to be seen and presents a unique risk assessment overview that allows a user to more accurately and efficiently determine overall organizational risks than merely viewing specific risk factors in isolation. Furthermore, instead of the user having to drill down various pages to obtain enterprise-related information for the sub-department, that sub-department's page information can be provided to the prioritized risk summary portion 402 and risk summary portion 403. This reduces the requirement for extensive drilling down, browsing, clicking, and querying needed to obtain specific department or other enterprise-related information.

As shown in FIG. 4B, the core element risk cube plot 401 includes one or more risk assessment points 412, which are graphical indicators (e.g., circles) based on a plot of their corresponding risk (likelihood) score and consequence score. Each graphical indicator 412 may further includes a numeral (414) representing multitude of scores at that plotted risk point. The graphical indicator may have a frequency count of compliance subjects having the associated risk score and corresponding consequence score. For example, the plot at B3 in the GUI shown in FIG. 4B includes a graphical numeral with the number “40” in the middle to indicate a frequency count of 40 core elements having an associated “B” level of risk, with a correspondence “3” level of consequence level. In some examples, the risk assessment points 412 may be represented by circles, while a risk mitigation point may be represented by triangles. The described graphical user interface method advantageously provides a user with access to all information related to risk compliance for all compliance subjects in a concise manner, unlike existing technologies, which require extensive drilling down, clicks, and navigation, as described herein.

In some aspects, each risk assessment point 412 may be configured to, responsive to receiving input from a user (e.g., a click from a user input device), “drill down” to or identify the compliance subjects having the associated risk score and corresponding consequence level. For example, upon selecting a risk assessment point 412, the CAMS module 101 may generate an inset GUI displaying the names of the compliance subjects associated with that risk assessment point 512. In other examples, the inset GUI may be implemented as a modal window, pop-up window, tooltip, or link to a compliance risk summary report (as shown in FIG. 8).

FIG. 5 depicts a graphical user interface 500 for rendering a compliance risk dashboard for a compliance manager (e.g., compliance program manager) according to an exemplary aspect. The GUI 500 includes one or more graphical charts indicating a training summary for all core elements, as well as a mitigation summary for all core elements. In one aspect, the GUI 500 may include a training summary region 502 indicating a first proportion of employees having completed training related to the compliance subject and a second proportion of remaining employees to complete the training. In the example shown in FIG. 5, the training summary region 502 indicates 92% of employees (or 2,087 employees) have completed training of all compliance subjects, and 8% of remaining employees (i.e., or 185 employees) to undergo the training. The training summary region 502 may further indicate the training status separated between low risk and high-to-medium risk compliance subjects.

In another aspect, the GUI 500 may include a mitigation status region 504 indicating a first proportion of open mitigation plans for reducing risk of misconduct, a second proportion of completed mitigation plans, and a third proportion of past due mitigation plans. For example, as shown in FIG. 5, the mitigation status region 504 indicates 44% of compliance subjects (i.e., 28 core elements) have open mitigation plans, 52% of compliance subjects (i.e., 24 core elements) have completed mitigation plans, and 4% of compliance subjects (i.e., 2 core elements) have mitigation plans that are past due. Similar to the training summary region 502, the mitigation status region 504 may further indicate the mitigation status separated between low risk and high-to-medium risk compliance subjects.

The described graphical user interface method provides the user with concise information about the status of training and mitigation plans within an organization. In contrast to conventional systems which might require multiple contacts and time-consuming progress meetings, the described graphical user interface method rapidly provides the user with summaries, across a business entity, of ongoing progress in addressing the risk issues within the organization.

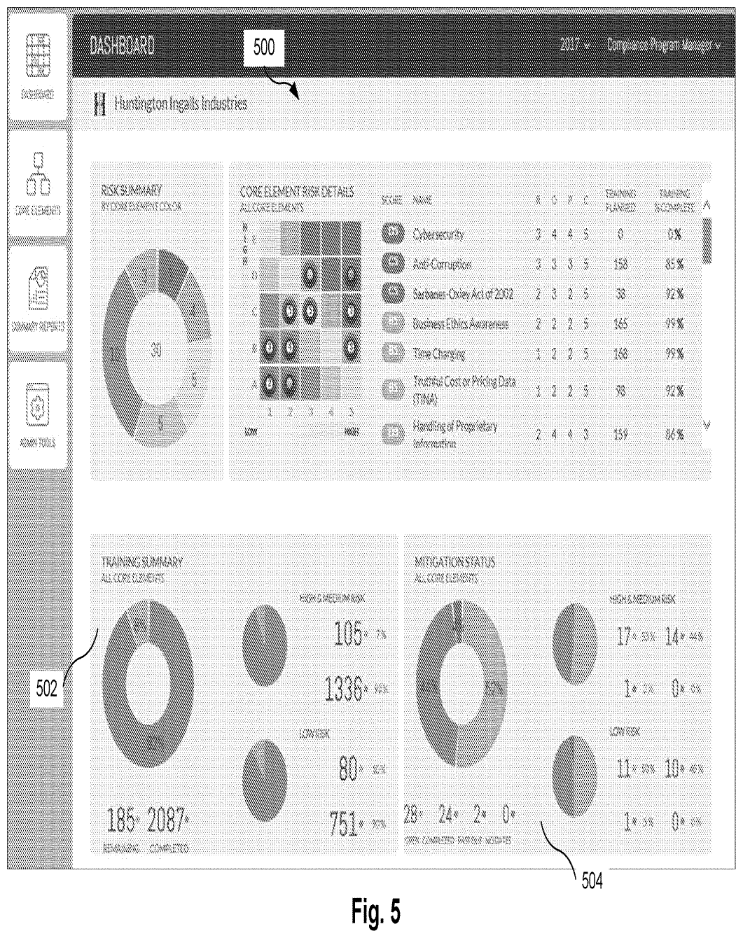

FIG. 6 depicts a graphical user interface 600 for rendering a compliance risk dashboard for a user (e.g., compliance director) according to an exemplary aspect. The GUI 600 includes a mitigation status page (highlighted by its navigation tab 604). The mitigation status page provides a status indication 606 for each business entity within the organization (e.g., the entire enterprise, subsidiaries, and business units). Each business entity includes a graphical chart 608 (e.g., pie chart) indicating the completion status (e.g., open, completed, past due, no dates) of a mitigation plan being performed for reducing risk within the organization. The described graphical user interface shown in FIG. 6 allows a user (e.g., a top-level executive) to assess the mitigation plan status of a multitude of business entities (subsidiaries, business units, or the entire enterprise). The user may utilize the GUI 600 to rapidly identify a business entity that may be past due or falling behind in addressing their risk issues, and then direct resources to that business entity in support.

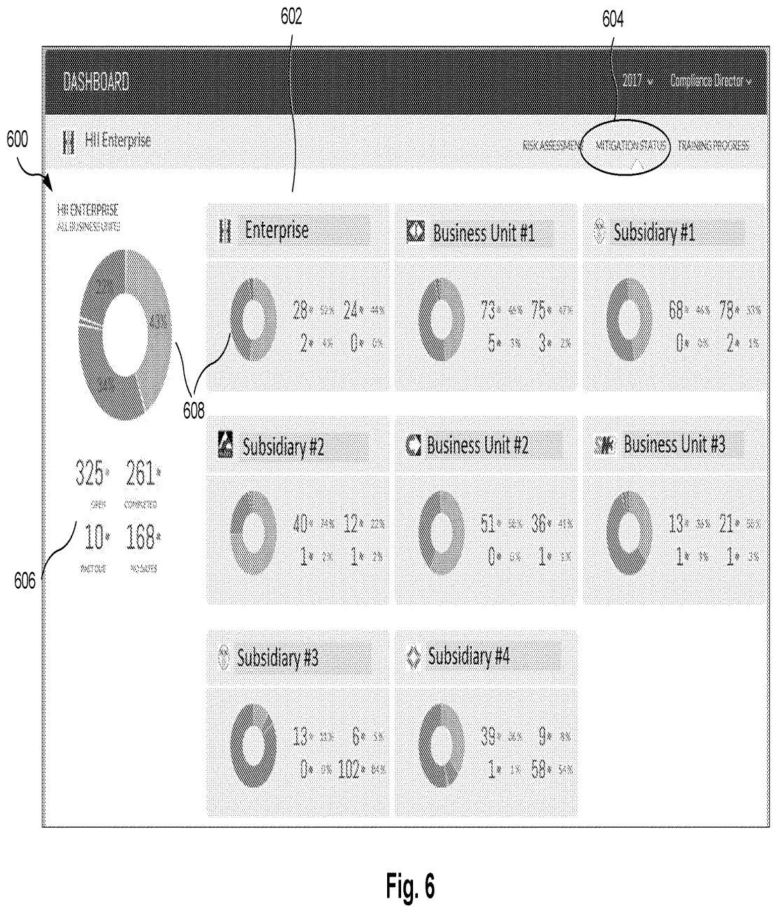

FIG. 7 depicts a graphical user interface 700 for rendering a compliance risk dashboard for a user (e.g., compliance director) according to an exemplary aspect. The GUI 700 includes a training progress page 702 (highlighted by its navigation tab 704). The training progress page 702 provides a status indication 706 for each business entity within the organization (e.g., the entire enterprise, subsidiaries, and business units). Each business entity includes a graphical chart indicating the training progress (e.g., remaining, completed) of employees within that business unit related to a particular core element.

Similar to the GUI 600 described above, the described graphical user interface 700 shown in FIG. 7 enables a user to assess the training status of a multitude of business entities (subsidiaries, units, or the entire enterprise). For example, the user may utilize the GUI 700 to rapidly identify any business entities that have deviated significantly from the training completion status of other business entities. In doing so, the GUI 700 facilitates the user with directing resources to that identified business entity that have not completed all prescribed training.

FIG. 8 and FIG. 9 depict graphical user interfaces 800, 900 for rendering summary reports on compliance risk status according to an exemplary aspect. The CAMS module 101 may generate one or more summary reports from several different search criteria, including certain core elements, or business units. The search criteria may change depending on the report being requested. The GUI 800 may include a plurality of form fields 802 for specifying the various search criteria. FIG. 8 depicts a compliance risk summary that is prioritized by total risk, however other summaries may be prioritized by the “R” component scores, such as in FIG. 9 (sorted by the column 902), or give the user the ability to prioritize by R, 0, P, or C component scores.

In one embodiment, the CAMS module 101 may generate a compliance risk comparison report that provides a comparison of core elements between business units or divisions. This comparison report allows visibility into whether like core elements are assessed differently across the entire enterprise. In some embodiments, the CAMS module may generate a training summary report, which is a list of compliance training and statistics depending on the search criteria. As noted earlier herein, this is advantageous because instead of the user having to drill down various pages to obtain enterprise-related information for the sub-department, that sub-department's page information can be provided to one or more of the summary reports described herein. This reduces the requirement for extensive drilling down, browsing, clicking, and querying needed to obtain specific department or other enterprise-related information.

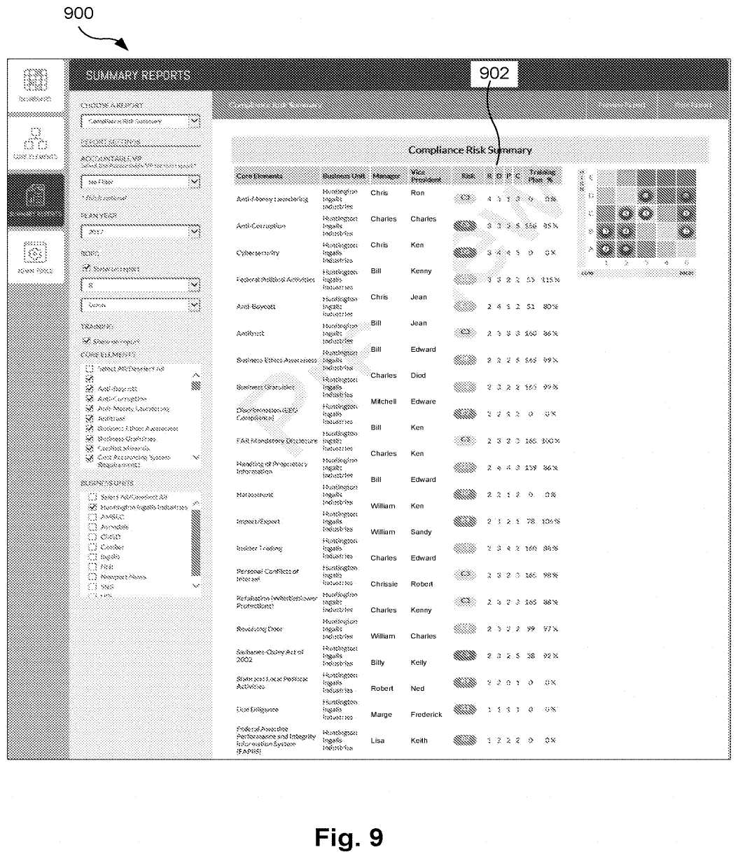

FIG. 10 depicts a graphical user interface 1000 for specifying a core element according to an exemplary aspect. In some embodiments, the CAMS module 101 may provide a core element home screen as shown in FIG. 10 for viewing and editing general information (1002) about the compliance subject. The core element home screen may have one or more fields for editing the core element description, a plan year, a core element manager, a law department representative, and text describing: a listing of applicable statutes and regulation, corporate policies and procedures, division policy and procedures, an at-risk audience, the process designed to detect misconduct, a department in a position to detect misconduct, training information. The GUI 1000 may further include a portion 1004 specifying actions of a mitigation plan, a portion 1008 specifying metrics to determine compliance, and a portion 1010 displaying associated signature blocks that represent approval by one or more individuals of the mitigation plan. The GUI 1000 may further include a version history 1006 for tracking changes made to the core element information.

In some aspects, the GUI 1000 includes a risk cube plot 1012 associated with the compliance subject of which the core element home screen specifies. The risk cube plot 1012 includes a risk assessment point 1014 which is a graphical indicator (depicted as a circle shape) for the current level of risk assessed for the compliance subject. The risk cube plot 1012 further includes a risk mitigation point 1016 which is a graphical indicator (depicted as a triangle shape) for a target level of risk that will be achieved after completion of a risk mitigation plan for the compliance subject.

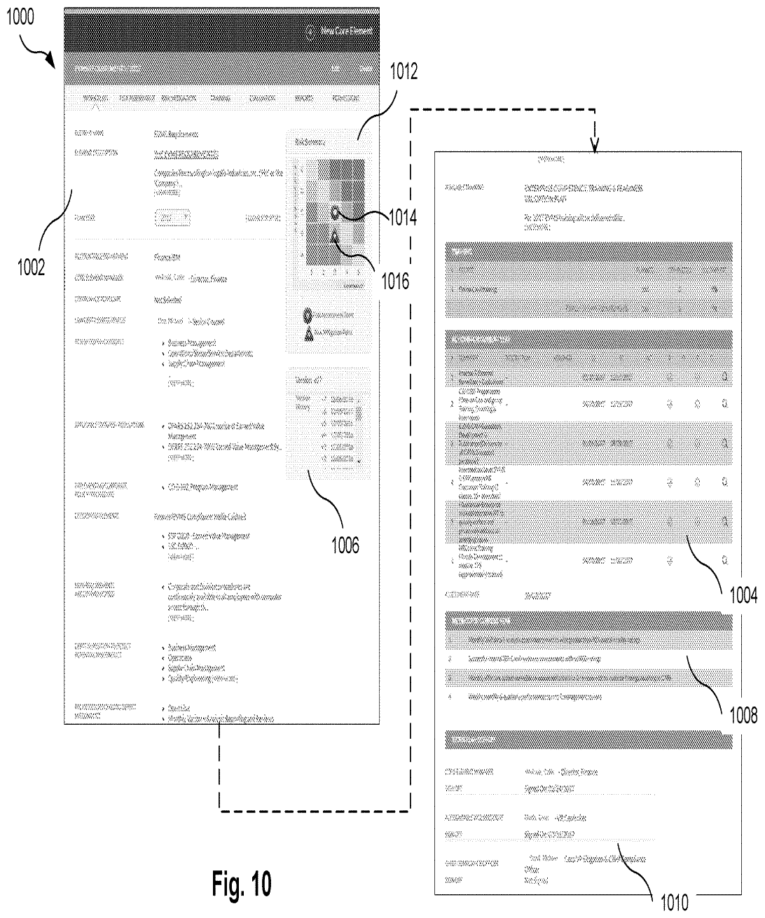

FIG. 11 depicts a graphical user interface 1100 for determining a risk assessment of a core element or compliance subject according to an exemplary aspect. In one embodiment, the CAMS module may provide a user interface 1100 for inputting the risk assessment for a compliance subject. As shown, the user interface 1100 may contain text indicating the criteria for assessing rationalization, pressure, opportunity, and consequence scores as described in Tables 1 to 4 above. The GUI 1100 may include a portion 1101 configured to receive user input indicating a component score (e.g., rationalization, opportunity, pressure, consequence). In one implementation, the portion 1101 may include radio button or other control elements for numeric values 0 to 5 corresponding risk assessments of highly unlikely to highly likely, respectively. The CAMS module 101 may be configured to calculate the score inputs to generate a circle plot on the risk cube plot 1102 as part of the GUI 1100.

The described graphical user interface method ensures a uniform risk assessment methodology is applied across a corporate organization by clearly indicating the criteria and considerations to be used for assessing a risk level of a compliance subject. In contrast to conventional systems, this graphical user interface prevents an individualized or ad hoc approach to risk assessment, which would otherwise reduce the accuracy of any risk summaries derived therefrom. The described graphical user interface advantageously ensures that the risk assessment produced by the system 100 for a given compliance subject can be accurately compared to another compliance subject in another part of the enterprise. This can be contrasted with alternatives, such as merely providing a spreadsheet or index of such disparate data, which would not only lack the comparable context provided through the graphical user interface described herein, but would require scrolling or otherwise navigating through more data than could be readably displayed on a single page on most electronic devices or display screens thereof.

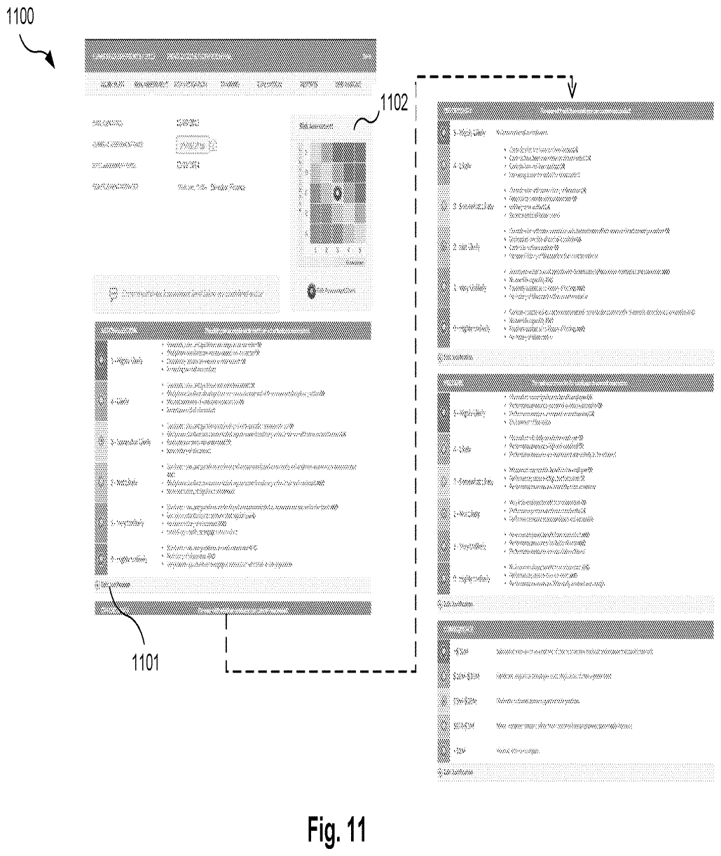

FIG. 12 depicts a graphical user interface 1200 for generating a risk mitigation plan for a core element or compliance subject according to an exemplary aspect. In some embodiments, the CAMS module 101 may generate a user interface 1200 for setting up a mitigation plan that reduces compliance risk within the organization. At portion 1201, the CAMS module 101 may receive an input from the user indicating one or more activities that will be completed in the current time period (e.g., year) to reduce risk by end of the current time period (year). At portion 1202 of the GUI 1200, the CAMS module may receive input from the user indicating a selection of a “future” risk assessment for ROPC assuming the mitigation plan is successful. That is, the future risk assessment for the compliance subject represents a target level of risk that will be achieved after completion of a risk mitigation plan for the compliance subject. The “future” risk assessment may be graphically represented on the risk cube plot by a triangle shape (e.g., risk mitigation point 1016 as described earlier with FIG. 10). At portion 1203 of the GUI, the CAMS module 101 may receive an input from the user indicating the scheduled start of the activity and scheduled completion of the activity. At portion 1204 of the GUI, the CAMS module 101 may receive input selections for R, 0, P, and C component scores that identify which risk attribute the mitigation plan improves. The portion 1204 of the GUI 1200 further includes a justification field for entering text notes related to reasons for the selected risk assessment.

The described graphical user interface method advantageously provides a reliable method for generating a risk mitigation plan and directing resources to quantitatively address risk issues. The described graphical user interface enables a user to generate a centralized and formalized plan with concrete target delivery dates and assignments.

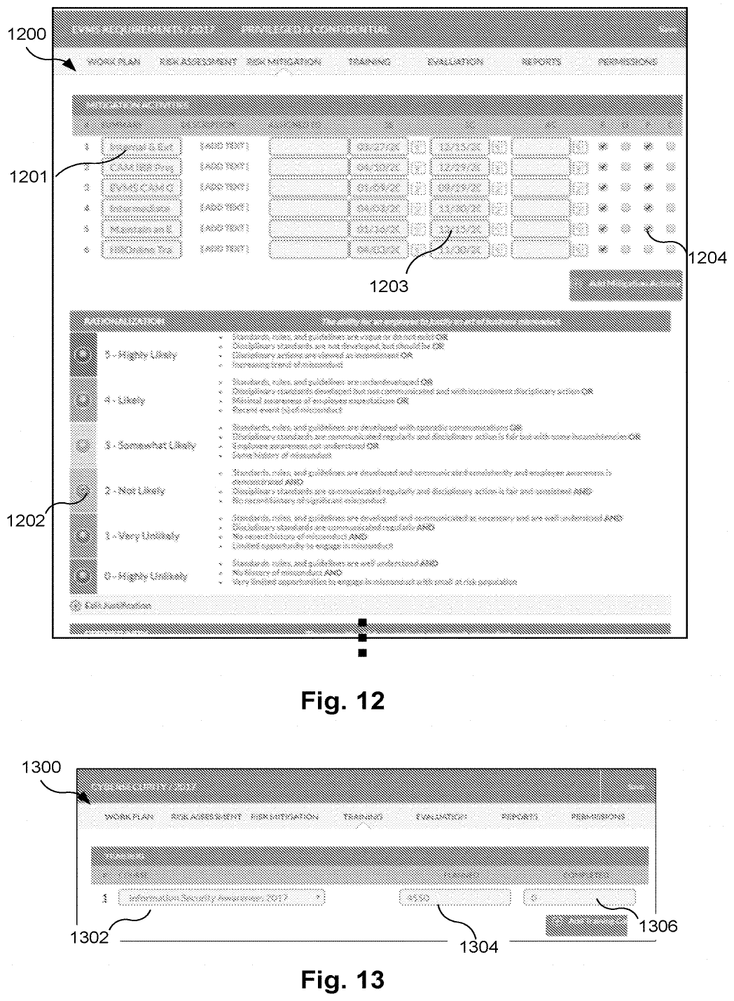

FIG. 13 depicts a graphical user interface 1300 for displaying and editing training status information for a core element or compliance subject according to an exemplary aspect. In some embodiments, the CAMS module 101 may receive user input indicating the training status of one or more employees in a business unit with regards to a compliance subject. In the example shown in FIG. 13, the GUI 1300 indicates the training status for compliance with the Cybersecurity subject. The GUI 1300 includes a first field 1302 for specifying one or more training courses (e.g., the selected course entitled “Information Security Awareness 2017”). The GUI 1300 may also include a second field 1304 for specifying the number of employees planned to undergo the training (e.g., the Planned field), and a third field 1306 for specifying the number of employees that have completed the training (e.g., the Completed field). The CAMS module 101 may generate and modify a dashboard or training summary report GUI that indicates the training progress of the organization.

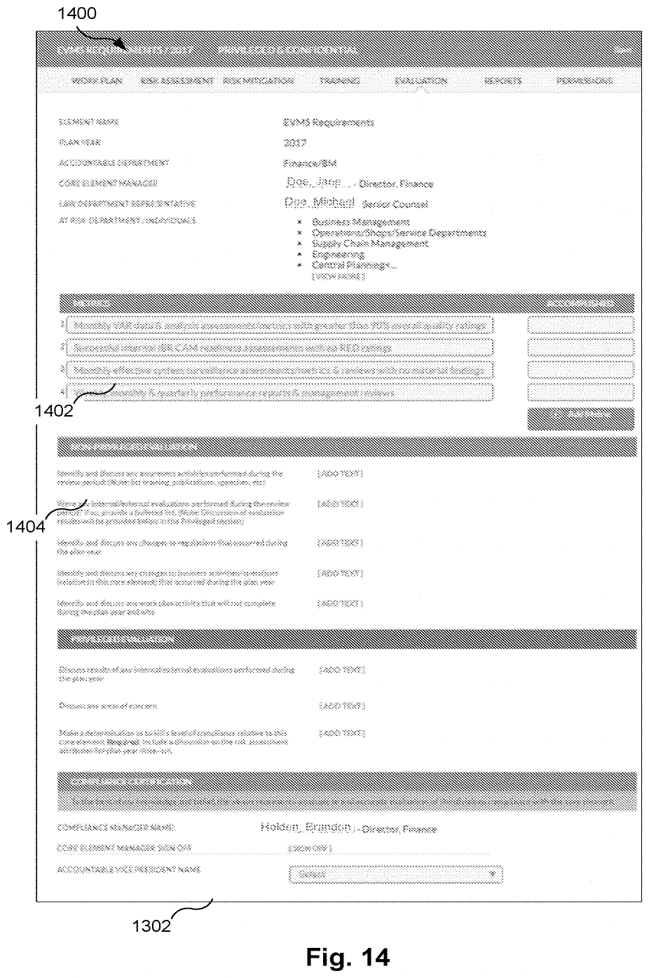

FIG. 14 depicts a graphical user interface 1400 for generating an evaluation of a core element or compliance subject according to an exemplary aspect. In some embodiments, the CAMS module 101 may provide an input screen (e.g., GUI 1400) for evaluating the core element, i.e., a yearly evaluation that is used to describe any changes to the compliance core element throughout a given year. In one aspect, the GUI 1400 may include a portion 1402 for specifying one or more metrics for evaluating a compliance subject, as well as a second portion 1404 for adding text for non-privileged and privileged evaluation. The described graphical user interface advantageously enables a user to identify accountable parties and specify metrics for improving risk issues for a compliance subject.

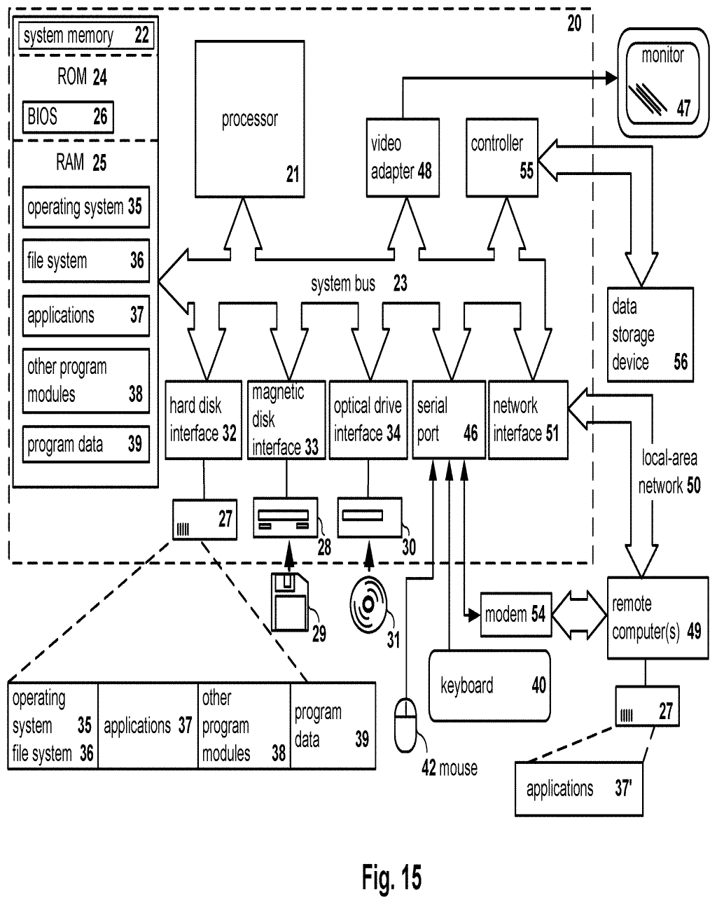

FIG. 15 is a block diagram illustrating a general-purpose computer system 20 on which aspects of systems and methods for scanning web pages may be implemented in accordance with an exemplary aspect. It should be noted that the computer system 20 can correspond to the servers and systems described above, for example, in FIG. 1.

As shown, the computer system 20 (which may be a personal computer or a server) includes a central processing unit 21, a system memory 22, and a system bus 23 connecting the various system components, including the memory associated with the central processing unit 21. As will be appreciated by those of ordinary skill in the art, the system bus 23 may comprise a bus memory or bus memory controller, a peripheral bus, and a local bus that is able to interact with any other bus architecture. The system memory may include permanent memory (ROM) 24 and random-access memory (RAM) 25. The basic input/output system (BIOS) 26 may store the basic procedures for transfer of information between elements of the computer system 20, such as those at the time of loading the operating system with the use of the ROM 24.

The computer system 20, may also comprise a hard disk 27 for reading and writing data, a magnetic disk drive 28 for reading and writing on removable magnetic disks 29, and an optical drive 30 for reading and writing removable optical disks 31, such as CD-ROM, DVD-ROM and other optical media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the computer system 20.

An exemplary aspect comprises a system that uses a hard disk 27, a removable magnetic disk 29 and a removable optical disk 31 connected to the system bus 23 via the controller 55. It will be understood by those of ordinary skill in the art that any type of media 56 that is able to store data in a form readable by a computer (solid state drives, flash memory cards, digital disks, random-access memory (RAM) and so on) may also be utilized.

The computer system 20 has a file system 36, in which the operating system 35, may be stored, as well as additional program applications 37, other program modules 38, and program data 39. A user of the computer system 20 may enter commands and information using keyboard 40, mouse 42, or any other input device known to those of ordinary skill in the art, such as, but not limited to, a microphone, joystick, game controller, scanner, etc. Such input devices typically plug into the computer system 20 through a serial port 46, which in turn is connected to the system bus, but those of ordinary skill in the art will appreciate that input devices may be also be connected in other ways, such as, without limitation, via a parallel port, a game port, or a universal serial bus (USB). A monitor 47 or other type of display device may also be connected to the system bus 23 across an interface, such as a video adapter 48. In addition to the monitor 47, the personal computer may be equipped with other peripheral output devices (not shown), such as loudspeakers, a printer, etc.

Computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes.

Network connections can form a local-area computer network (LAN) 50 and a wide-area computer network (WAN). Such networks are used in corporate computer networks and internal company networks, and they generally have access to the Internet. In LAN or WAN networks, the personal computer 20 is connected to the local-area network 50 across a network adapter or network interface 51. When networks are used, the computer system 20 may employ a modem 54 or other modules well known to those of ordinary skill in the art that enable communications with a wide-area computer network such as the Internet. The modem 54, which may be an internal or external device, may be connected to the system bus 23 by a serial port 46. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a general purpose computer (such as the one described in greater detail in FIG. 15, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for monitoring status of compliance subjects using a graphical user interface, the method comprising:
determining a risk score for an entity in an organization, wherein the risk score indicates a likelihood of misconduct associated with a compliance subject by an employee within the entity, wherein the compliance subject is indicative of a category of rules or regulations with which the organization is required to comply;
determining a consequence score associated with the compliance subject;
generating a graphical user interface comprising a risk plot region; and
at least partially in response to the determining of the risk score and the determining of the consequence score, causing a rendering, within the graphical user interface, of at least one graphical indicator in a specific location within the risk plot region, wherein the at least one graphical indicator comprises a frequency count of compliance subjects having the associated risk score and corresponding consequence score.

2. The method of claim 1, wherein determining the risk score further comprises:
determining a rationalization component score representing an ability of the employee to justify an act of misconduct;
determining an opportunity component score representing a difficulty with which the employee can commit the act of misconduct;
determining a pressure component score representing a motive for the employee to commit the act of misconduct; and
determining the risk score based on the rationalization component score, the opportunity component score, and the pressure component score.

3. The method of claim 2, further comprising:
determining the risk score as a summation of numerical values of the rationalization component score, the opportunity component score, and the pressure component score.

4. The method of claim 1, further comprising:
generating a second graphical user interface associated with a risk mitigation plan for a first compliance subject of the compliance subjects, wherein the second user interface comprises a first portion for receiving input specifying one or more activities to be completed to reduce a risk level of the first compliance subject, and a second portion for receiving input specifying a risk mitigation point that represents a future risk assessment for the first compliance subject after the risk mitigation plan has been completed.

5. The method of claim 1, wherein the graphical user interface further comprises a training summary region indicating a first proportion of employees having completed training related to the compliance subject and a second proportion of remaining employees to complete the training.

6. The method of claim 1, wherein the graphical user interface further comprises a mitigation status region indicating a first proportion of open mitigation plans for reducing risk of misconduct, a second proportion of completed mitigation plans, and a third proportion of past due mitigation plans.

7. The method of claim 1, further comprising:
receiving a user selection of the frequency count of compliance subjects having the associated risk score and the corresponding consequence score; and
generating, in response to receiving the user selection of the frequency count, a second graphical user interface comprising a listing of the compliance subjects having the associated risk score and the corresponding consequence score.

8. A system for monitoring status of compliance subjects using a graphical user interface, the system comprising:
a display device; and
a processor configured to:
determine a risk score for an entity in an organization, wherein the risk score indicates a likelihood of misconduct associated with a compliance subject by an employee within the entity, wherein the compliance subject is indicative of a category of rules or regulations with which the organization is required to comply;
determine a consequence score associated with the compliance subject;
generate, for display on the display device, a graphical user interface comprising a risk plot region;
at least partially in response to determining of the risk score and of the consequence score, cause a rendering, within the graphical user interface, of at least one graphical indicator in a specific location within the risk plot region, wherein the at least one graphical indicator comprises a frequency count of compliance subjects having the associated risk score and corresponding consequence score.

9. The system of claim 8, wherein the processor configured to determine the risk score is further configured to:
determine a rationalization component score representing an ability of the employee to justify an act of misconduct;
determine an opportunity component score representing a difficulty with which the employee can commit the act of misconduct;
determine a pressure component score representing a motive for the employee to commit the act of misconduct; and
determine the risk score as a summation of numerical values of the rationalization component score, the opportunity component score, and the pressure component score.

10. The system of claim 8, wherein the compliance subjects include categories or types of rules or regulations with which the organization is required to comply.

11. The system of claim 8, further comprising:
generating a second graphical user interface associated with a risk mitigation plan for a first compliance subject of the compliance subjects, wherein the second user interface comprises a first portion for receiving input specifying one or more activities to be completed to reduce a risk level of the first compliance subject, and a second portion for receiving input specifying a risk mitigation point that represents a future risk assessment for the first compliance subject after the risk mitigation plan has been completed.

12. The system of claim 8, wherein the graphical user interface further comprises a training summary region indicating a first proportion of employees having completed training related to the compliance subject and a second proportion of remaining employees to complete the training.

13. The system of claim 8, wherein the graphical user interface further comprises a mitigation status region indicating a first proportion of open mitigation plans for reducing risk of misconduct, a second proportion of completed mitigation plans, and a third proportion of past due mitigation plans.

14. The system of claim 8, wherein the processor is further configured to:
receive a user selection of the frequency count of compliance subjects having the associated risk score and the corresponding consequence score; and
generate, for display on the display device and in response to receiving the user selection of the frequency count, a second graphical user interface comprising a listing of the compliance subjects having the associated risk score and the corresponding consequence score.

15. A non-transitory computer readable medium comprising computer executable instructions for monitoring status of compliance subjects using a graphical user interface, including instructions for:
determining a risk score for an entity in an organization, wherein the risk score indicates a likelihood of misconduct associated with a compliance subject by an employee within the entity, wherein the compliance subject is indicative of a category of rules or regulations with which the organization is required to comply;
determining a consequence score associated with the compliance subject;
generating a graphical user interface comprising a risk plot region;
at least partially in response to the determining of the risk score and the determining of the consequence score, causing a rendering, within the graphical user interface, of at least one graphical indicator in a specific location within the risk plot region, wherein the at least one graphical indicator comprises a frequency count of compliance subjects having the associated risk score and corresponding consequence score.

16. The non-transitory computer readable medium of claim 15, wherein the instructions for determining the risk score further comprises instructions for:
determining a rationalization component score representing an ability of the employee to justify an act of misconduct;
determining an opportunity component score representing a difficulty with which the employee can commit the act of misconduct;
determining a pressure component score representing a motive for the employee to commit the act of misconduct; and
determining the risk score based on the rationalization component score, the opportunity component score, and the pressure component score.

17. The non-transitory computer readable medium of claim 16, further comprising instructions for:
determining the risk score as a summation of numerical values of the rationalization component score, the opportunity component score, and the pressure component score.

18. The non-transitory computer readable medium of claim 15, further comprising:
generating a second graphical user interface associated with a risk mitigation plan for a first compliance subject of the compliance subjects, wherein the second user interface comprises a first portion for receiving input specifying one or more activities to be completed to reduce a risk level of the first compliance subject, and a second portion for receiving input specifying a risk mitigation point that represents a future risk assessment for the first compliance subject after the risk mitigation plan has been completed.

19. The non-transitory computer readable medium of claim 15, wherein the graphical user interface further comprises a training summary region indicating a first proportion of employees having completed training related to the compliance subject and a second proportion of remaining employees to complete the training.

20. The non-transitory computer readable medium of claim 15, wherein the graphical user interface further comprises a mitigation status region indicating a first proportion of open mitigation plans for reducing risk of misconduct, a second proportion of completed mitigation plans, and a third proportion of past due mitigation plans.

21. The non-transitory computer readable medium of claim 15, further comprising:
receiving a user selection of the frequency count of compliance subjects having the associated risk score and the corresponding consequence score; and
generating, in response to receiving the user selection of the frequency count, a second graphical user interface comprising a listing of the compliance subjects having the associated risk score and the corresponding consequence score.
